(19) United States
(12) Patent Application Publication
(10) Pub. No.: US 2023/0272881 A1
(43) Pub. Date: Aug. 31, 2023

(54) DEVICE FOR STORING CRYOGENIC FLUID AND VEHICLE COMPRISING SUCH A DEVICE

(71) Applicant: L'Air Liquide, Société Anonyme pour l'Etude et l'Exploitation des Procédés Georges Claude, Paris (FR)

(72) Inventor: Thomas FAYER, Grenoble (FR)

(21) Appl. No.: 18/016,312

(22) PCT Filed: Jun. 21, 2021
(86) PCT No.: PCT/EP2021/066764

§ 371 Date: Jan. 13, 2023

(30) Foreign Application Priority Data
Jul. 16, 2020 (FR) FR2007456

(51) Int. Cl. F17C 3/08; B60P 3/22

(52) U.S. Cl. CPC F17C 3/08; B60P 3/2225; B60P 3/2295; F17C 2223/0161; F17C 2203/0329; F17C 2203/0391; F17C 2203/0629; F17C 2205/0107; F17C 2203/0646; F17C 2203/0643; F17C 2203/0663; F17C 2203/014; F17C 2270/0171; F17C 2221/012

(57) ABSTRACT

A device for storing cryogenic fluid including a sealed internal shell delimiting the storage volume for the cryogenic fluid, a thermal insulation layer disposed around the internal shell, and a sealed external shell disposed around the insulation layer. The space between the internal shell and the external shell being under vacuum, the external shell resting on the periphery of the thermal insulation layer, and the thermal insulation layer having an insulating material of the “pressure-responsive” type. Also including a protective shell disposed around the external shell, and at least one supporting component having an end connected rigidly to the internal shell and a second end rigidly connected to the protective shell such that such that the assembly having the internal shell. The external shell and the thermal insulation layer under vacuum is suspended in the protective shell via the at least one supporting component.

The invention relates to a device for storing cryogenic fluid and to a vehicle comprising such a device.

The invention relates more particularly to a device for storing cryogenic fluid comprising a sealed internal shell delimiting the storage volume for the cryogenic fluid, a thermal insulation layer disposed around the internal shell and a sealed external shell disposed around the insulation layer, the space between the internal shell and the external shell being under vacuum.

To allow the roll-out of hydrogen as a fuel in the transport sector, the storage of liquefied hydrogen needs to satisfy constraints relating to volume, shape, mass, mechanical integrity and cost.

Vacuum insulated tanks are generally very large and have a cylindrical shape (for vacuum resistance reasons).

The document US2004060304A describes such an architecture for cryogenic storage at relatively high pressure. Conventionally, the outer shell is a metal vacuum-resistant enclosure which needs to withstand a high mechanical stress (buckling) and as a result has a thickness suitable for this. Moreover, the internal structure is mechanically reinforced by spacers for withstanding vacuum-related loads.

One aim of the present invention is to remedy all or some of the drawbacks of the prior art that are set out above.

To this end, the device according to the invention, which is otherwise in accordance with the generic definition thereof given in the above preamble, is essentially characterized in that the external shell rests on the periphery of the thermal insulation layer, the thermal insulation layer comprising an insulating material of the “pressure-responsive” type such as “LRMLI” or “HLI”, the device also comprising a protective shell disposed around the external shell, the device comprising at least one supporting component comprising an end connected rigidly to the internal shell and a second end rigidly connected to the protective shell such that such that the assembly comprising the internal shell, the external shell and the thermal insulation layer under vacuum is suspended in the protective shell via the at least one supporting component.

Furthermore, embodiments of the invention may have one or more of the following features:
the at least one supporting component comprises a tubular neck,
the device has two supporting components disposed respectively at two ends of the device,
the thermal insulation layer is compressed in the direction of its thickness between the internal shell and the external shell,
the thermal insulation layer is compressed in the direction of its thickness between the internal shell and the external shell,
the thermal insulation layer is compressed in the direction of its thickness by a load of between 0.9 and 1.1 kgf/cm² and for example 1 kgf/cm²,
the thermal insulation layer is made up of radiation-impeding layers made for example from aluminum or double-sided aluminized PET and of spacers for these radiation-impeding layers, ensuring self-supporting, for example the spacers comprising a 3D printed structure and/or components molded in particular from plastic,
the internal shell is made of at least one of: stainless steel, aluminum, type 316L, 316Ti or 304L stainless steel, type 2024, 2219, 5083, 6061 or 7020 aluminum,
the internal shell has a thickness of between 1 and 10 mm, and preferably between 4 and 6 mm,
the external shell is made of at least one of: carbon steel, stainless steel, aluminum, titanium,
the external shell (4) has a thickness of between 0.1 and 5 mm, and in particular between 0.1 and 1 mm,
the protective shell is made of at least one of: Kevlar, carbon fibers, aramid fibers, composite, steel, stainless steel, aluminum, titanium,
the at least one supporting component comprises a tubular component comprising a wall forming at least one back-and-forth in a longitudinal direction between a first longitudinal end fixed to the internal shell, for example by welding, and a second longitudinal end fixed to the protective shell,
the at least one supporting component comprises a set of tie rods comprising an end connected to the protective shell,
the at least one supporting component comprises at least one ring which is disposed around the internal shell and the periphery of which is fixed to the protective shell,
the device comprises a thermal insulation, for example made of foam disposed between the external shell and the protective shell.

The invention also relates to a vehicle comprising a storage device according to any one of the preceding features.

According to one possible particular feature: the vehicle comprises a structure provided with a chassis or a set of walls, at least a part of the protective shell being formed by the chassis or set of walls and/or the protective shell being secured to the chassis or set of walls.

The invention may also relate to any alternative device or method comprising any combination of the features above or below within the scope of the claims.

Further particular features and advantages will become apparent upon reading the following description, which is provided with reference to the figures, in which:

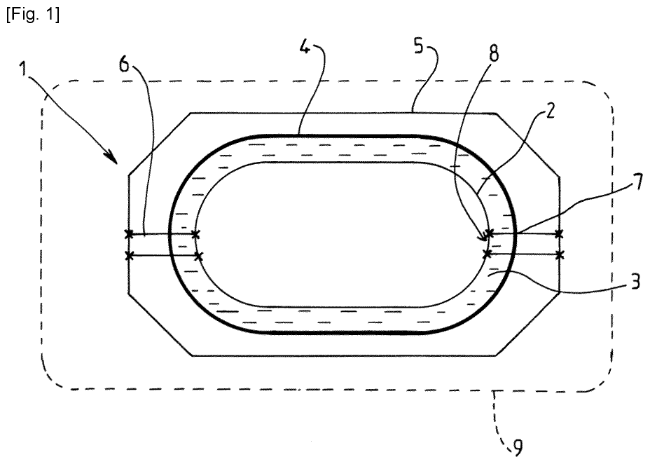

FIG. 1 shows a partial and schematic view in section illustrating a first example of the structure of a storage device according the invention,

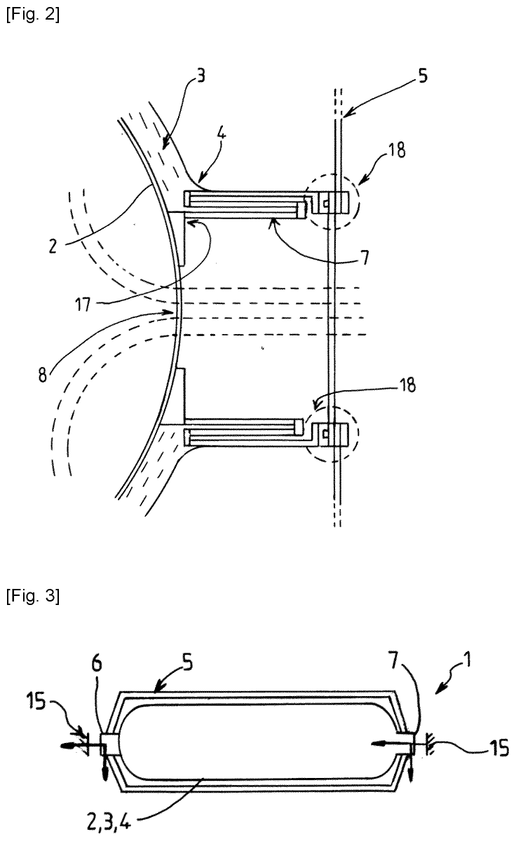

FIG. 2 shows a schematic and partial view in section illustrating an enlarged detail of said abovementioned device,

FIG. 3 shows a schematic and partial view in section illustrating an example of the assembly of such a device,

FIG. 4 shows a schematic and partial view in section illustrating an example of the integration of such an assembly of the device into a first vehicle,

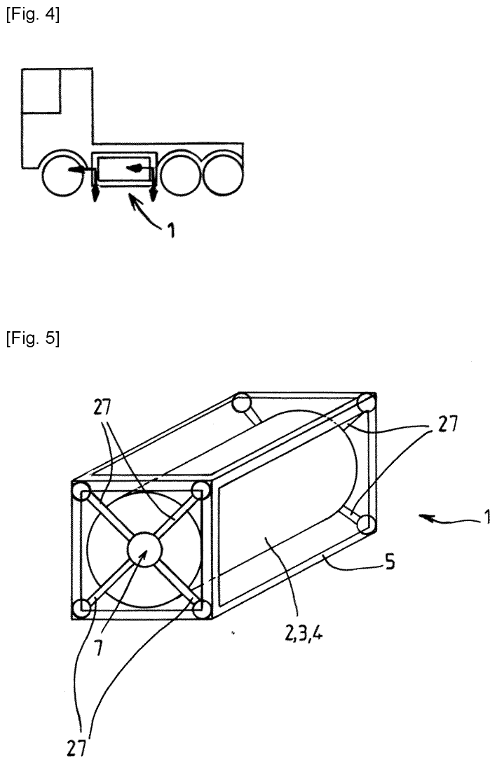

FIG. 5 shows a partial and schematic view in section illustrating a second example of the structure of a storage device according the invention,

FIG. 6 shows a partial and schematic perspective view illustrating a third example of the structure of a storage device according the invention,

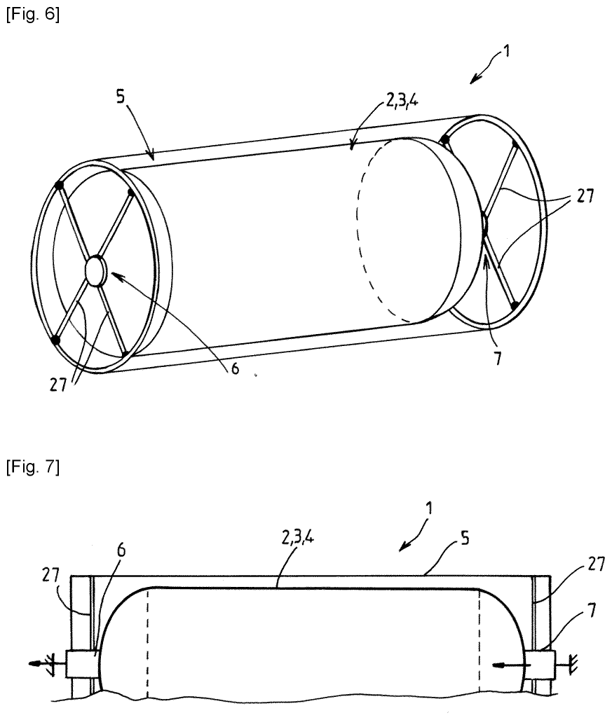

FIG. 7 shows a partial and schematic view in section of the third example of the structure of a storage device according the invention,

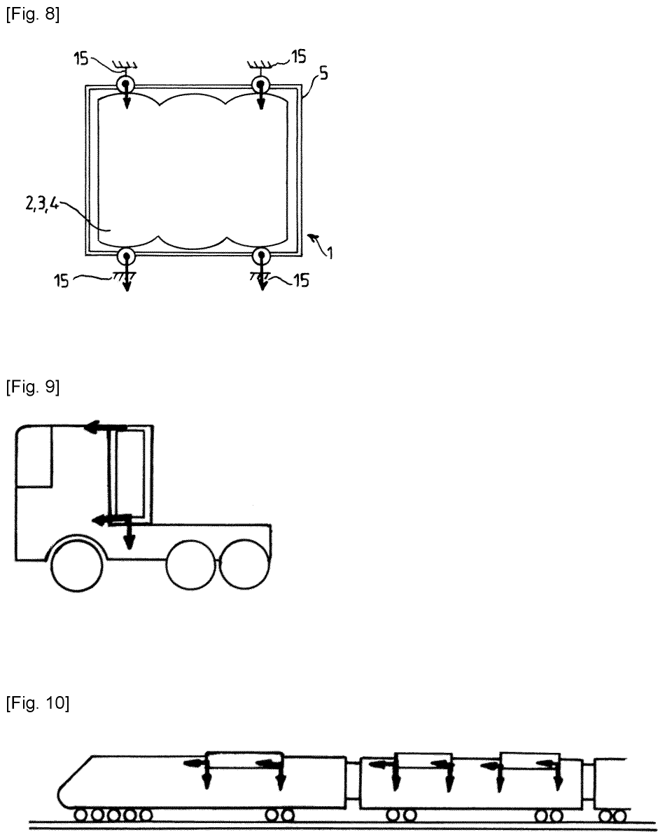

FIG. 8 shows a schematic and partial view in section illustrating another example of the assembly of such a device,

FIG. 9 shows a schematic and partial view in section illustrating another example of the integration of such an assembly of the device into a second vehicle,

FIG. 10 shows a schematic and partial view in section illustrating yet another example of the integration of such an assembly of the device into a second vehicle,

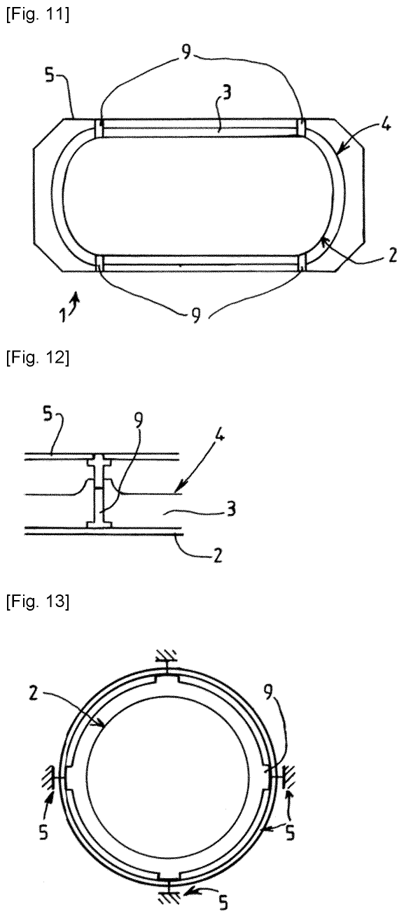

FIG. 11 shows a schematic and partial view in longitudinal section illustrating a fourth example of the structure of a storage device according the invention,

FIG. 12 shows an enlarged view in longitudinal section of a detail of [FIG. 11],

FIG. 13 shows a schematic and partial view in cross section of the device in [FIG. 11].

The device 1 for storing cryogenic fluid that is illustrated in particular in [FIG. 1] comprises a sealed internal shell 2 that delimits the storage volume for the cryogenic fluid.

The internal shell 2 may be made, for example, of at least one of: stainless steel, aluminum, type 316L, 316Ti or 304L stainless steel, type 2024, 2219, 5083, 6061 or 7020 aluminum, or any other alloy or composite material that is compatible with cryogenic temperatures. This internal shell 2 preferably has a thickness of between 1 and 10 mm, for example between 4 and 6 mm.

The device 1 also comprises a thermal insulation layer 3 disposed around the internal shell 2 and a sealed external shell 4 disposed around the insulation layer 2. The space between the internal shell 2 and the external shell 4 is under vacuum, that is to say at a pressure lower than atmospheric pressure and in particular between 10⁻³ and 10⁻⁶ mbar.

The external shell 4 rests (bears) on the periphery of the thermal insulation layer 3. For example, the thermal insulation layer 3 is thus compressed in the direction of its thickness between the internal shell 2 and the external shell 4. The thermal insulation layer 3 is, for example, compressed in the direction of its thickness by a load for example of around 1 kgf/cm², for example 1.1 kgf/cm² at sea level and a lower pressure at altitude (for example 0.2 kgf/cm² above 10 000 m).

For example, the external shell 4 may be made of at least one of: carbon steel or stainless steel, aluminum, polymer liner (for example PVC, PVDC, EVOH, PE or other polyolefins). This external shell 4 has for example a thickness of between 0.1 mm and 1 mm. This external shell 4 may thus have for example a flexible or semi-rigid structure ensuring vacuum-tightness and resting on the insulation 3.

The thermal insulation layer 3 comprises an insulating material of the “pressure-responsive multilayer insulation” type such as “LRMLI” (“Load Responsive Multi Layer Insulation”) and/or equivalent composite insulations using this kind of multilayer structure (in addition to a powder or foam insulation for example).

For example, the thermal insulation layer 3 may be made of a multilayer insulation such as those produced by the company Questhermal. Such insulation has for example the following structure: a superposition of typical (insulating) layers with load dynamic maintenance (structure of the “spring” type withstanding a compressive load of 1 kgf/cm²) and radiation-impeding layers (aluminum foil for example). For example, layers of Mylar separated by polymer spacers, cf. the publication “Integrated and Load Responsive Multi-Layer insulation” by S.A. Dye, Kopelove, Mills Cryogenics, vol. 52 April-June 2012. The difference from conventional types of MLI (“Multi-Layer Insulation”) resides in the capacity of the (“sprung”) insulating layer to keep the radiation-impeding layers spaced apart (at a distance of between 0.5 mm and 3 mm, for example 1.5 mm), in spite of a crushing stress of 1 kgf/cm² (via shape memory).

This type of insulation (LRMLI in particular) exhibits a thermal performance which can be slightly inferior to that of conventional multilayer structures (MLI) but have the advantage of being able to withstand greater mechanical loads, for example up to 1 kgf/cm². This makes it possible to send the mechanical stresses related to the placing of the internal shell 2 under vacuum directly to the insulation.

The insulation layer 3 has for example a thickness of between 0.5 and several centimeters, for example one centimeter (typically 1 to 2 cm for small tanks and up to 5 to 10 cm for the largest tanks such as the ones for trailers).

The device 1 also comprises a protective shell 5 disposed around the external shell 4. The device 1 also comprises at least one supporting component 6, 7 comprising an end rigidly connected to the internal shell 2 and a second end rigidly connected to the protective shell 5. Thus, the assembly comprising the internal shell 2, the external shell 4 and the thermal insulation layer 3 is suspended in the protective shell 5 via the at least one supporting component 6, 7.

The protective shell 5 may be made, for example, of at least one of: Kevlar, carbon fibers, synthetic aramid fibers (for example Nomex®), composite, steel, stainless steel, aluminum, titanium.

The protective shell 5 is preferably rigid and may have a cylindrical shape or any other shape.

As schematically depicted, the internal shell 2 and the external shell 4 comprise respective adjacent orifices 8 for the passage of circuitry. The at least one supporting component 6, 7 comprises for example a tubular neck disposed in the region of said aligned orifices 8.

Of course, this arrangement is not limiting and the pipework could pass outside the neck.

This novel type of insulation used in the invention was not envisioned in these applications on account of its relative thermal performance and also on account of its relative mass and its lower robustness in the known architectures under vacuum.

These drawbacks are at least partially overcome by the abovementioned architecture. Thus, the problem of robustness is overcome by integrating the structure in a protective shell 5 made of a lightweight and strong material or by directly integrating the assembly into the protective shell (metal structure 5 of a vehicle for example as described in detail below). This protective shell 5 may be part of the structure of the vehicle which integrates the device 1 (chassis, hull, fuselage/wing), engine protection, bumper, hold of a boat, etc.). This protective shell 5 may comprise a layer of Kevlar or carbon fiber before being integrated into the structure that accommodates it (made of aluminum or steel for example).

This configuration makes it possible to limit the mechanical stresses on the external and/or structural shell 4 by virtue of the structure in which the thermal insulation layer 3 is “self-supported”.

This architecture also makes it possible to do away with the cylindrical shape that is virtually systematically necessary for the structures according to the prior art (or makes it possible to optimize the mass of tanks with a cylindrical shape).

By thus dissociating the insulation function and the protective shell 5 of the store, it is also possible to adapt the thickness of the external shell 4 depending on the application (on land, at sea, in the air, civilian, military, etc.) or on its position in the vehicle which integrates the device (part exposed or not exposed to external attack).

Intermediate insulation (made of foam or the like) may also be integrated, if necessary, between the external shell 4 and the protective shell 5, in order to limit the consequences of an accidental loss of vacuum.

As illustrated in the examples in [FIG. 1] to [FIG. 7], the device 1 may have two supporting components 6, 7 disposed respectively at two ends, for example two longitudinal ends (in particular when the device has a cylindrical shape).

As illustrated in [FIG. 2], the supporting components 6, 7 may each comprise a tubular component comprising a wall forming at least one back-and-forth along a longitudinal direction between a first longitudinal end 17 fixed to the internal shell 2, for example by welding, and a second longitudinal end 18 fixed to the protective shell 5 by screwing or welding (with clamping and interposition of one or more seals, if necessary). This structure with a “back-and-forth” of walls along the longitudinal direction is provided in order to lengthen the thermal path between the two ends fixed to elements at different temperatures.

Of course, this structure is not limiting, and so simpler shapes (without a “back-and-forth”) may also be envisioned, for example with necks made of titanium.

The device 1 may contain any cryogenic fluid, in particular liquefied hydrogen.

As illustrated in [FIG. 3], the device may be mounted by way of its two longitudinal ends 6, 7 on a support 15, for example a vehicle (for example a rolling vehicle, cf. [FIG. 4]). The two ends can thus react the longitudinal and transverse loads (symbolized by the arrows).

In the example in [FIG. 5], the supporting components 6, 7 have tie rods connecting the tubular component (connected to the shells 2, 4) to an exterior frame 5. The frame 5 comprises for example a mechanically welded frame of rods, which may be attached to a vehicle structure or is already part of the vehicle structure.

In the example in [FIG. 6], the supporting components 6, 7 have tie rods connecting the tubular component (neck(s) connected to the shells 2, 4) to a tubular exterior frame 5. The frame 5 comprises for example a tube that is part of the chassis of a vehicle. For example, the transverse tie rods 27 connect the necks of the shells to rings secured to the chassis 5.

As schematically depicted in [FIG. 7], this makes it possible to react the longitudinal and transverse loads.

In the example in [FIG. 8], the shells 2, 4 have a planar shape (parallelepipedal overall shape), the store is housed in a protective shell 5 or casing of complementary shape, which may be attached to an exterior structure 15 at several (for example four) points. This assembly may be mounted vertically (cf. [FIG. 9] or horizontally (cf. [FIG. 10]) in a vehicle. As above, the longitudinal and transverse loads are reacted (symbolized by arrows).

Thus, the architecture of the device allows optimized integration in a vehicle.

This solution is more advantageous than the tanks of the prior art, which used the structure of the vehicle as a shell under vacuum, since these known solutions accumulate mechanical stresses at the outer shell.

The solution proposed makes it more easily possible to produce tanks with parallelepipedal shapes or having an optimized mass.

Optionally, partitioning of the sections under vacuum may be provided in order to limit the consequences in the event of an accident loss of vacuum.

An additional saving of mass may be achieved via the use of one or more stiffeners inside the internal shell 2 (in particular if the tank is flat).

The choice of the constituent material of the protective shell 5 may also be determined so as to confer on the device one or more additional features (fire resistance, UV protection, corrosion protection, antistatic properties, etc.).

[FIG. 11], [FIG. 12] and [FIG. 13] show another embodiment variant of the one or more supporting components. In this example, the at least one supporting component comprises two rings 19 which are disposed (fixed) around the internal shell 2 and the peripheries of which are fixed to the protective shell 5. This or these rings 19 may be provided alternatively (or additionally, if appropriate) on the supporting neck(s) 6, 7. As can be seen in [FIG. 13], the periphery of these rings 9 may be fixed at several points to the protective shell 5.

These rings may be made of at least one of: epoxy, aluminum, stainless steel, a metal. These rings may have complex shapes in order to lengthen the thermal path between the two shells 2, 5.

If necessary, at least a part of the pipework could pass through a ring 9, for example extending all around the periphery of the internal shell 2.

1.-18. (canceled)

19. A device for storing cryogenic fluid, comprising:
a sealed internal shell delimiting the storage volume for the cryogenic fluid,
a thermal insulation layer disposed around the internal shell, and
a sealed external shell disposed around the insulation layer,
the space between the internal shell and the external shell being under vacuum,
the external shell resting on the periphery of the thermal insulation layer,
the thermal insulation layer comprising an insulating material of the “pressure-responsive” type,
a protective shell disposed around the external shell,
at least one supporting component comprising an end connected rigidly to the internal shell and a second end rigidly connected to the protective shell such that such that the assembly comprising the internal shell,
wherein the external shell and the thermal insulation layer under vacuum is suspended in the protective shell via the at least one supporting component.

20. The device as claimed in claim 19, wherein the at least one supporting component comprises a tubular neck.

21. The device as claimed in claim 19, further comprising two supporting components disposed respectively at two ends of the device.

22. The device as claimed in claim 19, wherein the thermal insulation layer is compressed in the direction of thickness between the internal shell and the external shell.

23. The device as claimed in claim 19, wherein the thermal insulation layer is compressed in the direction of thickness by a load of between 0.9 and 1.1 kgf/cm².

24. The device as claimed in claim 19, wherein the space under vacuum between the internal shell and the external shell is formed by a plurality of mutually independent partitioned sub-volumes under vacuum.

25. The device as claimed in claim 19, wherein the thermal insulation layer is made up of radiation-impeding layers and of spacers for these radiation-impeding layers, ensuring self-supporting.

26. The device as claimed in claim 19, wherein the internal shell is made of at least one of: stainless steel, aluminum, type 316L, 316Ti or 304L stainless steel, type 2024, 2219, 5083, 6061 or 7020 aluminum.

27. The device as claimed in claim 19, wherein the internal shell has a thickness of between 1 and 10 mm.

28. The device as claimed in claim 19, wherein the external shell is made of at least one of: carbon steel, stainless steel, aluminum, titanium.

29. The device as claimed in claim 19, wherein the external shell has a thickness of between 0.1 and 5 mm.

30. The device as claimed in claim 19, wherein the protective shell is made of at least one of: Kevlar, carbon fibers, aramid fibers, composite, steel, stainless steel, aluminum, titanium.

31. The device as claimed in claim 19, wherein the at least one supporting component comprises a tubular component comprising a wall forming at least one back-and-forth in a longitudinal direction between a first longitudinal end fixed to the internal shell, and a second longitudinal end fixed to the protective shell.

32. The device as claimed in claim 19, wherein the at least one supporting component comprises a set of tie rods comprising an end connected to the protective shell.

33. The device as claimed in claim 19, wherein the at least one supporting component comprises at least one ring which is disposed around the internal shell and the periphery of which is fixed to the protective shell.

34. The device as claimed in claim 19, further comprising a thermal insulation disposed between the external shell and the protective shell.

35. A vehicle comprising a storage device as claimed in claim 19.

36. The vehicle as claimed in claim 35, the vehicle comprising a structure provided with a chassis or a set of walls, wherein at least a part of the protective shell is formed by the chassis or set of walls and/or the protective shell is secured to the chassis or set of walls.
